(19) United States
(12) Patent Application Publication
(10) Pub. No.: US 2003/0100359 A1
(43) Pub. Date: May 29, 2003

(54) Audio network for gaming machines

(76) Inventors: Timothy C. Loose, Chicago, IL (US); Eric M. Pryzby, Skokie, IL (US); Wayne H. Rothschild, Northbrook, IL (US); Shridhar P. Joshi, Skokie, IL (US)

Correspondence Address: Michael J. Blankstein, WMS Gaming Inc., 800 South Northpoint Boulevard, Waukegan, IL, 60085, US

(21) Appl. No.: 10/342,817

(22) Filed: Jan. 16, 2003

Related U.S. Application Data
(63) Continuation-in-part of application No. 09/679,093, filed on Oct. 4, 2000.

(51) Int. Cl. A63F 13/00

(52) U.S. Cl. 463/20

(57) ABSTRACT

A gaming machine includes a processor, a memory device, and an audio speaker system. The processor randomly selects a game outcome in response to a wager amount. The memory device is coupled to the processor and stores a plurality of audio data sets for producing a plurality of different audio outputs. The processor selects one of the plurality of audio data sets in response to the processor receiving audio instructions from an external control source electronically coupled to the gaming machine. The audio speaker system broadcasts the selected audio output to a player of the gaming machine. Further, a gaming machine network comprises a plurality of gaming machines and a central controller electronically coupled to the gaming machines. The central controller sends audio instructions for controlling the audio outputs from the audio speaker system of the gaming machines. The audio instructions may include digitally formatted audio data.

### RELATED APPLICATIONS

This application is a continuation-in-part of U.S. patent application Ser. No. 09/679,093, filed Oct. 4, 2000, which is incorporated herein by reference in its entirety. This application is also being filed concurrently with U.S. patent application Ser. No. ______ (Attorney Docket No. 47079-00160USPT) entitled “Gaming Machine Environment Having Controlled Audio And Visual Media Presentation,” U.S. patent application Ser. No. ______ (Attorney Docket No. 47079-00162USPT) entitled “Player-Selectable Audio Preferences For A Gaming Machine,” and U.S. patent application Ser. No. ______ (Attorney Docket No. 47079-00163USPT) entitled “Gaming System With Surround Sound,” all of which are assigned to the assignee of the present application and all of which are incorporated herein by reference in their entireties.

### FIELD OF THE INVENTION

The present invention relates generally to gaming machines and, more particularly, to a gaming machine and a gaming machine network having an enhanced audio output.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Consequently, shrewd operators strive to employ the most entertaining and exciting machines available because such machines attract frequent play and, hence, increase profitability to the operator. Accordingly, in the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “secondary” or “bonus” game which may be played in conjunction with a “basic” game. The bonus game may comprise any type of game, either similar to or completely different from the basic game, which is entered upon the occurrence of a selected event or outcome of the basic game. Such a bonus game produces a significantly higher level of player excitement than the basic game because it provides a greater expectation of winning than the basic game and is accompanied by more attractive or unusual video displays and/or audio.

Most types of enhancement, however, have focused primarily on visual effects. For example, gaming machines may included various types of displays for displaying different images in an “attract mode” to stir interest in players. And, the visual effects of the game features, such as reels and symbols, have been changed to be more attractive.

While these player-appeal features provide some enhanced excitement relative to other known games, there is a continuing need to develop new features for gaming machines to satisfy the demands of players and operators. Preferably, such new features will further enhance the level of player excitement. The present invention is directed to satisfying these needs.

### SUMMARY OF THE INVENTION

To satisfy the aforementioned needs, the gaming machine of the present invention includes a processor, a memory device, and an audio speaker system. The processor randomly selects one of a plurality of outcomes of the gaming machine in response to a wager amount. The memory device is coupled to the processor and stores a plurality of audio data sets for producing a plurality of different audio outputs. The processor selects one of the plurality of audio data sets in response to the processor receiving audio instructions from an external control source electronically coupled to the gaming machine. The audio speaker system broadcasts the selected one of the plurality of audio outputs to a player of the gaming machine.

The present invention further contemplates a gaming machine network comprising a plurality of gaming machines and a central controller. Each gaming machine of the plurality of gaming machines includes a processor for randomly selecting one of a plurality of outcomes of the gaming machine in response to a wager amount. Each gaming machine also includes an audio speaker system that broadcasts an audio output to a player of the gaming machine. The central controller is electronically coupled to each of the plurality of gaming machines. The central controller sends audio instructions for controlling the audio outputs from the audio speaker system of each of the plurality of gaming machines. The audio instructions may be instructions for the gaming machine to select a certain audio data set stored within the gaming machine or to download a certain audio data set stored external to the gaming machine. Further, the audio instructions may include the audio data (e.g., digitally formatted data) that is processed by the gaming machine to broadcast the desired audio output to the player.

Alternatively, the gaming machine network may include a plurality of electronically interconnected gaming machines. Instead of or in addition to a central controller of the network sending the audio instructions, one of the plurality of gaming machines sends the audio instructions to the other gaming machines for controlling the audio output from the audio speaker systems of the other games.

The present invention also contemplates novel methods for transmitting audio data to gaming machines and for selectively controlling audio outputs of gaming machines.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a simplified front view of a slot machine embodying the present invention.

FIG. 2A is a block diagram of a control system suitable for operating the gaming machine in FIG. 1.

FIG. 2B is an alternative block diagram to FIG. 2A illustrating a gaming machine having an audio peripheral control system coupled to the main CPU.

FIG. 3 illustrates one embodiment of a gaming system architecture in which a bank of gaming machines are connected to a central controller.

FIG. 4 illustrates an alternative gaming system architecture in which a bank of gaming machines are connected to each other and to a central controller.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

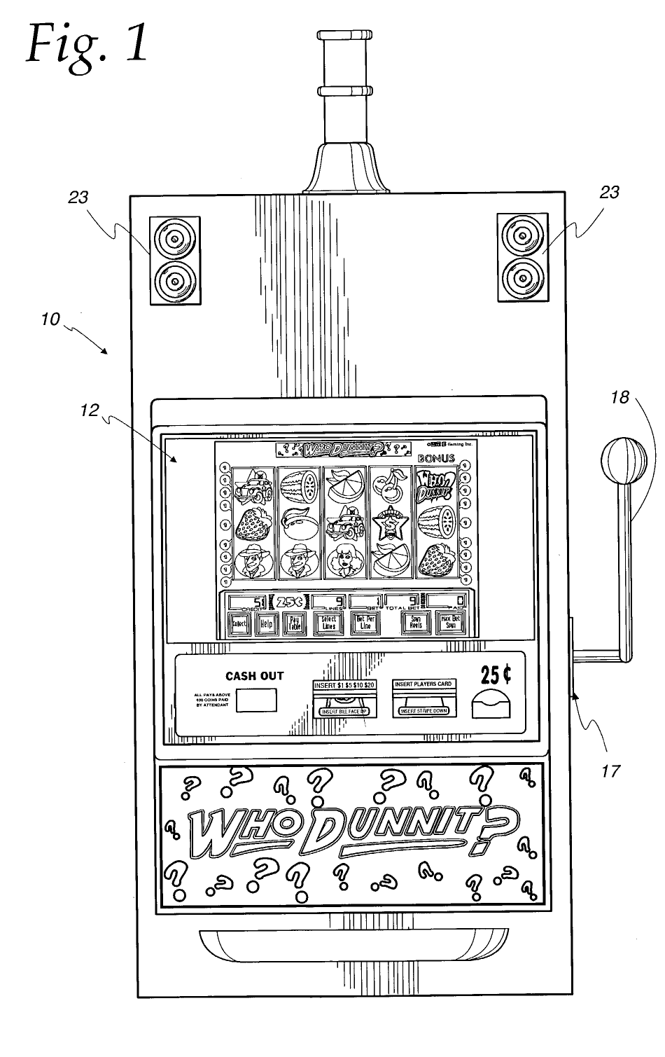

Turning now to the drawings and referring initially to FIG. 1, a video gaming machine 10 is depicted that may be used to implement a bonus game according to the present invention. The gaming machine 10 includes a video display 12 that may comprise a dot matrix, CRT, LED, LCD, electro-luminescent display, or generally any type of video display known in the art. In the illustrated embodiment, the gaming machine 10 is an “upright” version in which the video display 12 includes a touch screen and is oriented vertically relative to the player. It will be appreciated, however, that any of several other models of gaming machines are within the scope of the present invention, including, for example, a “slant-top” version in which the video display is slanted at about a 30° angle toward the player, or gaming machines that include mechanical, rather than video, displays.

In one embodiment, the gaming machine 10 is operable to play a game entitled WHO DUNNIT?™ having a mystery theme. The WHO DUNNIT?™ game features a basic game in the form of a slot machine with five simulated spinning reels and a bonus game with strategy options directing game activities on the video display 12. It will be appreciated, however, that the gaming machine 10 may be implemented with games other than the WHO DUNNIT?™ game and/or with several alternative game themes.

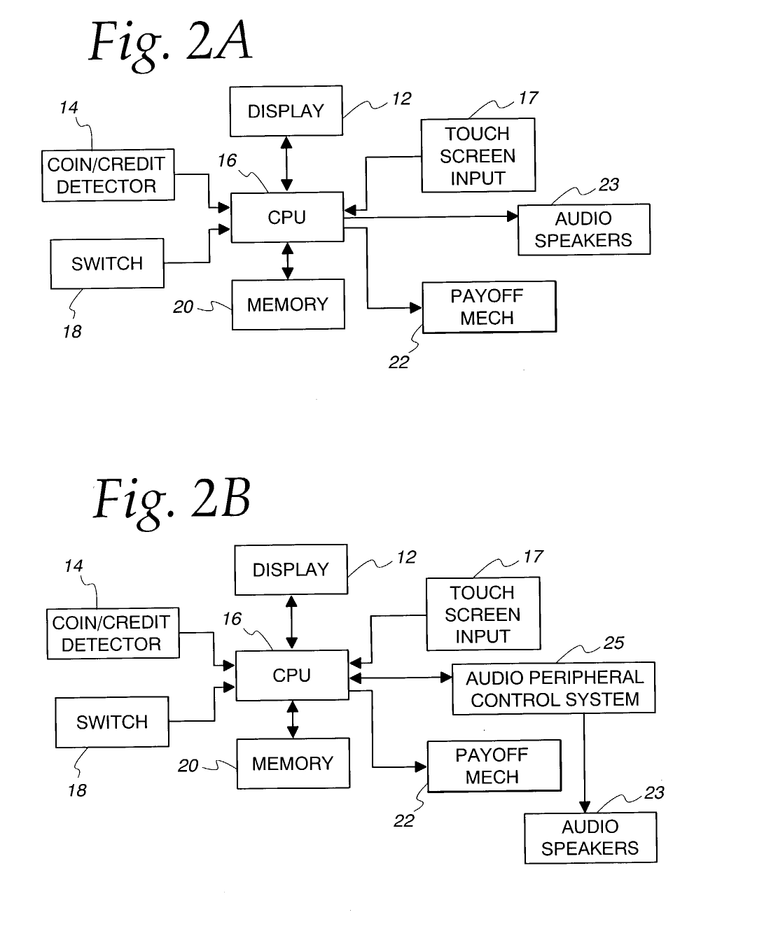

FIG. 2A is a block diagram of a control system suitable for operating the gaming machine 10. Coin/credit detector 14 signals a CPU 16 when a player has inserted a number of coins or played a number of credits. Then, the CPU 16 executes a game program which causes the video display 12 to display the basic game that includes simulated reels with symbols displayed thereon. The player may select the number of paylines to play and the amount to wager via touch screen input keys 17. The basic game commences in response to the player activating a switch 18 in a lever or push button, causing the CPU 16 to set the reels in motion, randomly select a game outcome, and then stop the reels to display symbols corresponding to the pre-selected game outcome. In one embodiment, certain basic game outcomes cause the CPU 16 to enter a bonus mode, which causes the video display 12 to show a bonus game, as is known in the art.

A system memory 20 stores control software, operational instructions, and data associated with the gaming machine 10. In one embodiment, the system memory 20 comprises a separate read-only memory (ROM) and battery-backed random-access memory (RAM). It will be appreciated, however, that the system memory 20 may be implemented on any of several alternative types of memory structures or may be implemented on a single memory structure. A payoff mechanism 22 is operable in response to instructions from the CPU 16 to award a payoff of coins or credits to the player in response to certain winning outcomes which may occur in the basic game or bonus game. The payoff amounts corresponding to certain combinations of symbols in the basic game are predetermined according to a pay table stored in system memory 20. The payoff amounts corresponding to certain outcomes of the bonus game are also stored in system memory 20.

As shown in FIGS. 1 and 2A, the gaming machine 10 also includes audio speakers 23 for broadcasting audio output to the player of the game and other spectators adjacent the game. The audio output may include various outputs, such as messages related to the game being played, messages unrelated to the game, a certain type of music (e.g., rock, classical, jazz, etc.), or music related to a theme of a game. The audio speakers 23 are usually located on the front portion of the cabinet and include just one speaker or a plurality of audio speakers 23. The speakers 23 may be arranged in a planar along the front of the gaming machine, or they can be positioned in a non-planar fashion around the player of the game. In a further alternative, the speakers 23 may be configured to deliver surround sound to the player.

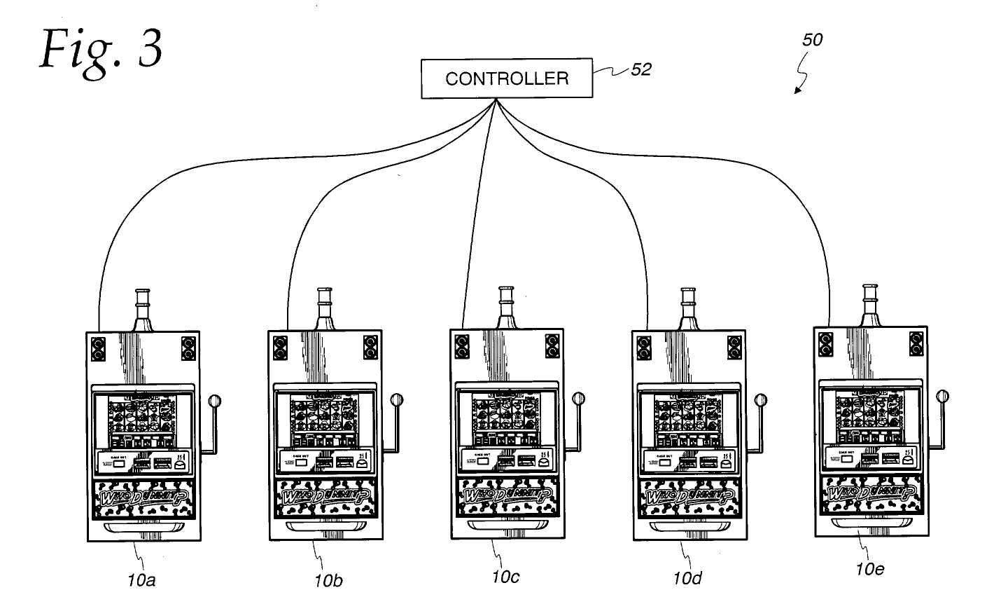

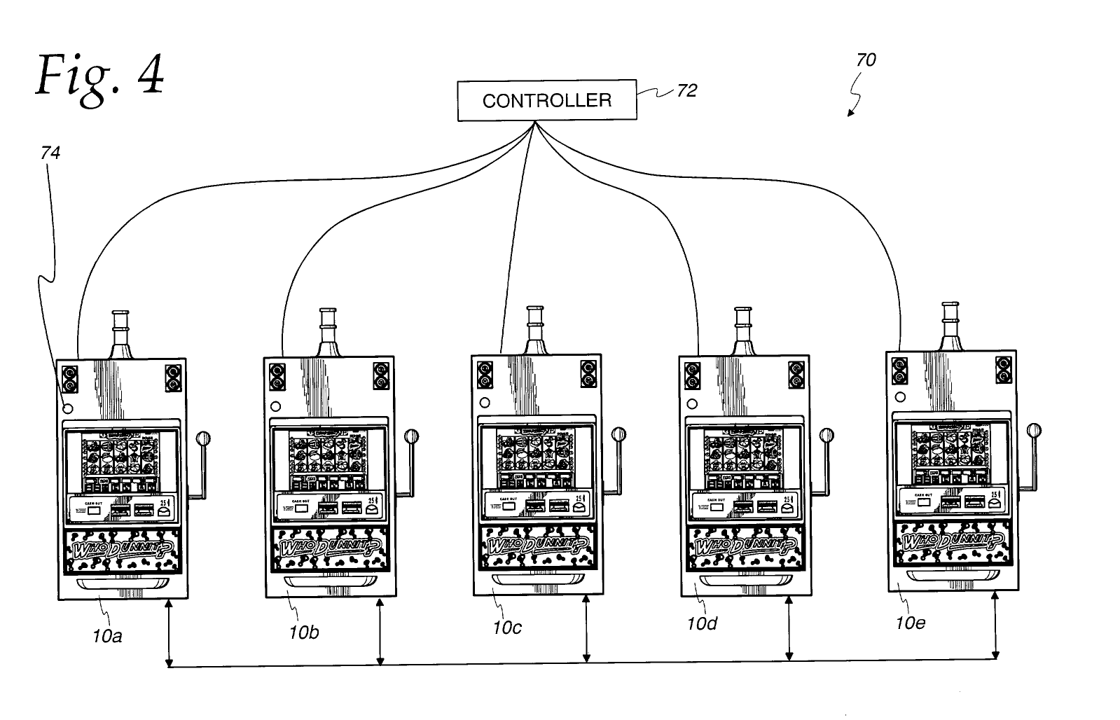

In the basic system configuration, the gaming machine 10 stores a plurality of audio data sets in the memory 20. The CPU 16 then selects the audio data set that is processed for broadcasting the selected audio output to the speakers 23. The CPU 16 can do so in response to certain events, some of which are discussed below with respect to FIGS. 3 and 4. Preferably, the audio data sets are stored in a digital format. As such, the gaming machine 10 must include components and circuitry for converting the digital data to analog audio signals and amplifying those analog signals to produce an output from the speakers 23. In one preferred embodiment, the audio data is stored in a surround-sound format for broadcasting a surround-sound audio output from a plurality of surround speakers 23 spatially arranged around the gaming machine 10.

FIG. 2B illustrates an alternative control system that is different from FIG. 2A in that it has a distinct audio peripheral control system 25 for controlling the audio output from the speakers 23. The audio peripheral control system 25 preferably has its own controller or microprocessor that has access to its own audio memory device that stores the audio data sets. Further, the audio peripheral control system 25 has the A/D converters, amplifiers, and other drive circuitry necessary to broadcast the audio output from the speakers 23. In short, the control system of FIG. 2B allows for all of the audio signal processing to occur on a peripheral device, thereby allowing for a more sophisticated audio experience without overburdening the CPU 16 and the memory 20 of the gaming machine 10.

Referring now to FIG. 3, a gaming machine system architecture 50 is illustrated that includes a central controller 52 that is linked to a plurality of gaming machines 10a-10e. The system architecture allows for various aspects of the gaming machines 10a-10e, such as the audio elements of the game (i.e., audio outputs), to be controlled by an external device which, in this case, is the controller 52. For example, when the real time is a predetermined time, the central controller 52 can send audio instructions to the gaming machines 10a-10e that cause each gaming machine 10a-10e to select a certain audio data set that is used for broadcasting a certain audio output. This predetermined time can be a certain time of a day, a certain day of the week, or a certain day of a year. For example, the audio instructions having a holiday-specific theme can be transmitted from the controller 52 to the gaming machines 10a-10e on certain holidays, such as Valentine's Day, St. Patrick's Day, Mardi Gras, Easter, the 4^{th} of July, Halloween, Thanksgiving, Christmas, New Year's Eve, and New Year's Day.

In another example of controlling the audio output, the system architecture 50 is useful for determining which type of audio outputs or other types of player appeal features are the favorite among players. In the system architecture 50, the wager inputs for each of the plurality of gaming machines 10a-10e are monitored by the controller 52. The controller 52 may intermittently download information on the wager inputs at selected times or continuously download information for real time updates. A correlation exists between the favorite audio outputs, or other player appeal features, and the total amount of wager inputs for the associated machine on which the audio outputs are broadcast. When the controller 52 determines that a particular player appeal feature is the favorite of players, it then takes the necessary steps to inform a particular one of the gaming machines 10a-10e, which is not displaying or broadcasting the favorite audio output, to begin playing the favorite audio output. In other words, the amount of wager input to each machine is a feedback mechanism by which the controller 52 determines which of the audio elements and/or other player appeal features is the favorite, thereby causing that favorite to be broadcast more frequently on other machines 10a-10e. For example, the favorite visual element or audio element may be displayed for more than 75% of any day or 75% of any week.

In addition to the feedback mechanism described above with reference to FIG. 3, the internal controller (e.g., CPU 16 in FIG. 2) of one particular gaming machine 10 may monitor the wager inputs for that machine while different audio elements are being broadcast (or other player appeal features are being displayed/broadcast) so that the controller internally determines which of the audio outputs are the most appealing to the players. Once the favorite of the players is determined, the internal controller for the gaming machine 10 begins to play that player appeal feature more frequently. Because the amount of wager inputs is also a function of the number of people in the casino, which is a function of the day and the time of day, the controller of the internal machine or the controller 52 of the system architecture 50 of FIG. 3 may monitor wager inputs over a longer period of time, such as a week, in order to determine which of the player appeal features is the favorite.

Further, the gaming machine 10 or the system architecture 50 of FIG. 3 may determine the types of audio outputs that are the favorites at certain times of the day or on certain days of the week. This is due to the demographics of individuals entering the casino on certain days and at certain hours of the evening. Accordingly, knowing that a demographic group is most prevalent on Friday nights and Saturday nights, the gaming machine 10 and the system architecture 50 of FIG. 3 may act to determine the favorites on Friday nights and Saturday nights and broadcast those audio output favorites more on those nights than on other nights. Alternatively, a second demographic group may be more prevalent during the weekdays from 8:00 AM until 4:00 PM. Thus, the gaming machine 10 and the system architecture 50 of FIG. 3 may act to determine the favorites for this second demographic group and display those favorites at those hours.

In addition to the aforementioned time-based controlling of the audio output or the favorite-based controlling of the audio output, the controller 52 may selectively control the audio output of the gaming machines 10a-10e based on other triggering events. For example, if the first gaming machine 10a achieves a highly desired outcome, a corresponding signal indicative of the outcome can be transmitted to the controller 52, causing the controller 52 to send certain audio instructions to the gaming machine 10a to cause an audio output indicative of the outcome. This could be a message commending the player on the outstanding outcome or a message regarding the location in a casino at which the player shall receive the payout from casino personnel. The audio instructions could be in the form of instructions that cause the gaming machine 10a to play certain music, for example, the song “We Are The Champions” by the musical group Queen. Such music is indicative of the game outcome. Or, music that lacks lyrics indicative of the game outcome, but which is fast and upbeat could be broadcast from the gaming machine 10a after the desired game outcome is achieved.

A triggering event also includes a specific request by the player for a certain type of audio output, which may be accomplished by actuating certain I/O devices on the gaming machine 10. The triggering event may be a randomly chosen event or time as well. In short, the triggering events may result in the interruption of a first audio output, followed by the broadcasting of a second audio output.

In addition, the central controller 52 upon receipt of such a signal from the first gaming machine 10a can also cause certain audio outputs to be broadcast from the other gaming machines 10b-10d in the gaming machine bank, or only on the adjacent gaming machine 10b. In other words, the game outcome of one gaming machine 10a-10e can result in selected audio output being broadcast from one or more of the other gaming machines 10a-10e.

The central controller 52 may send different audio instructions to the different gaming machines 10a-10e. For example, each gaming machine 10a-10e may be instructed to broadcast a song from its speakers, but with different acoustical characteristics corresponding to different musical instruments. Or, if the gaming machine 10c has a winning outcome, audio instructions may be sent to gaming machine 10d which results in the audible message, “the player on your left is REAL happy” while audio instructions may be sent to gaming machine 10b which results in the audible message, “the player on your right is SUPER happy.” As another example, the gaming machines 10a-10e may be used to sequentially tell a message to the entire gaming area or room by each of them stating one word or a few words of a sentence, such as, “these gaming machines are just giving away money tonight!” Further, the central controller 52 can selectively control the broadcast of all of the speakers of the gaming machines 10a-10e to create a surround sound effect for the players of the gaming machines 10a-10e. Thus, by selectively controlling the audio outputs of each of the gaming machines 10a-10e, choreographed audio effects for the overall bank of gaming machines 10a-10e can be achieved

In any of these embodiments where the controller 52 is controlling the audio output, the gaming machines 10a-10e may have a library of known audio data sets that are stored in a local memory device, such as memory device 20 (FIG. 2A) or a memory device associated with an audio peripheral control system 25 (FIG. 2B). Alternatively, the gaming machines 10a-10e can each access a remote memory device that is linked in the network of the system architecture 50.

In yet a further embodiment, the system architecture 50 and the controller 52 are structured and configured to transmit audio instructions that contain the audio data. Thus, the gaming machines 10a-10e do not need to store the audio data sets in a memory device. The audio data sets transmitted from the controller 52 can take the form of analog audio signals or, preferably, digital audio signals. If digital, the transmission can be streaming audio signals or compressed audio signals. The audio data can also be in a surround-sound format if the speakers 23 (FIGS. 1-2) are spatially arranged to deliver this type of broadcasting.

The various formats for the audio data sets and speaker arrangements that can be used by all of the embodiments of the present invention are described in detail in U.S. patent application No. ______ entitled “Gaming System With Surround Sound” (filed on the same day as the present application, having common inventors as the present application, and being owned by the assignee of the present application), which is herein incorporated by reference in its entirety.

FIG. 4 illustrates an alternative system architecture 70 that is different from FIG. 3 in two respects. First, the gaming machines 10a-10e are all interconnected to each other, in addition to be coupled to a central controller 72. And second, each of the gaming machines 10a-10e has a microphone 74 that is capable of receiving audio input from players of the gaming machines 10a-10e.

The system architecture 70 allows one of the gaming machines 10a-10e to be the master that provides audio instructions to the remaining gaming machines 10a-10e. As an example, the gaming machine 10a may be the master that controls the is audio output of the other gaming machines 10b-10e (i.e., the slaves). As with previous embodiments, the audio instructions from gaming machine 10a may be in the form of instructions that selectively cause certain gaming machines 10b-10e to broadcast certain audio outputs that are derived from audio data sets stored in memory devices in each of those machines 10b-10e. Or, the master gaming machine 10a may be provided with an enhanced audio control system with additional memory that causes it to send streaming audio data or compressed audio data to each of the other gaming machines 10b-10e.

In the embodiment of FIG. 4, the central controller 72 is optional, but has been illustrated because it may provide more enhanced control of the audio output (and/or game functions) of the gaming machines 10a-10e. For example, the central controller 72 can be used to connect the bank of gaming machines 10a-10e to another bank of gaming machines in the vicinity to ensure that that there is no conflicting of audio outputs between the banks (e.g., ensuring that loud broadcasts of positive outcomes do not occur simultaneously between adjacent banks). Or, the controller 72 may provide the enhanced memory for storing a larger database of audio data sets that are selectively transmitted to the gaming machines 10b-10e under the control of the master gaming machines 10a.

The microphones 74 on each of the gaming machines 10a-10e provide the opportunity for an additional source of audio data to be broadcast from one or more of the gaming machines 10a-10e. As one example, if a winning outcome of $2000 is achieved in gaming machine 10a, the gaming machine 10a may broadcast a brief portion of James Brown's song “I Feel Good” and then send an audio message to the player stating, “That was awesome! How do you feel about being $2000 richer?” Presumably, the player may respond with an emphatic “I feel good!!” The player's words (i.e., acoustic signals) are then received via the microphone 74 (i.e., converted from acoustic signals to player-specific audio signals) and processed by the gaming machine 10a or central controller 72. The gaming machine 10a can then begin broadcasting a modified version of James Brown's “I Feel Good” with the player's own voice dubbed into the song. Further, the other gaming machines' 10b-10e can receive audio instructions from the gaming machine 10a (or the central controller 72) and broadcast the dubbed version of James Brown's “I Feel Good” in the winning player's voice.

Alternatively, instead of prompting the player, the microphone 74 on one of the gaming machines 10a-10e may receive various audible statements from a certain player after achieving a winning outcome. The audio data corresponding to the player's statements can then be synthesized with a voice synthesizer and replayed back to the player from the speakers after the next winning outcome. This same synthesized “parroting” can be done for negative outcomes too. In short, the microphones 74 provide an additional manner for achieving enhanced entertainment at the gaming machines 10a-10e.

Additionally, the present invention contemplates the use of player tracking cards (or other player-tracking concepts) in the gaming machines to determine the sound preferences of the player. For example, the player may simply want no audio output whatsoever. Or, knowing certain preferences, the type of audio output can be tailored to suit the player's desires based on the gaming machine or the central controller knowing information about the player.

Further, using player tracking with the present invention provides for additional functions that enhance entertainment. By having a “buddy list” on the player tracking card, the audio output associated with a winning outcome can be delivered by the central controller (or master gaming machine) to the gaming machines at which the winning player's buddies are playing, informing them of a certain winning outcome. The audio output at the buddies' gaming machines may be in the form of music, and can be accompanied by a message indicating that winning outcome, such as “Your buddy, Julio, just won $500.” Even further, in response to a winning outcome, the microphone 74 (FIG. 4) can allow the winning player to record a message (i.e., an audio output) that will be sent to the player's buddies listed on his player tracking card. For example, after achieving a certain type of outcome, the gaming machine can instruct the player to enter a message via the microphone 74 that will be broadcasted to his or her buddies. The player may state, “I'm buying dinner tonight!!”, which is then transmitted to the buddies' gaming machines and broadcast in the voice of the winning player.

While the present invention has been described with reference to one or more particular embodiments, those skilled in the art will recognize that many changes may be made thereto without departing from the spirit and scope of the present invention. For example, beyond the streaming audio data mentioned above, the audio signals can be produced from a live feed, such as a live announcer or a live band. Further, the gaming machines may be equipped to deliver the audio output to headphones (wired or wireless) that the player is wearing. Each of these embodiments and obvious variations thereof is contemplated as falling within the spirit and scope of the claimed invention, which is set forth in the following claims.

What is claimed is:

1. A gaming machine, comprising:
a processor for randomly selecting one of a plurality of outcomes of said gaming machine in response to a wager amount;
a memory device coupled to said processor and storing a plurality of audio data sets for producing a plurality of different audio outputs, said processor selecting one of said plurality of audio data sets in response to said processor receiving audio instructions from an external control source electronically coupled to said gaming machine; and
an audio speaker system for broadcasting one of said plurality of audio outputs corresponding to said selected one of said plurality of audio data sets.

2. The gaming machine of claim 1, wherein said plurality of audio data sets includes music.

3. The gaming machine of claim 1, wherein said processor sends a game outcome signal to said external control source, and said external control source sends said audio instructions in response to receiving said game outcome signal.

4. The gaming machine of claim 1, wherein said audio instructions are sent from said external control source at a predetermined time, said predetermined time being at least one day in a calendar year.

5. The gaming machine of claim 4, wherein said at least one day is a day selected from a group consisting of Valentine's Day, St. Patrick's Day, Mardi Gras, Easter, the 4^{th} of July, Halloween, Thanksgiving, Christmas, New Year's Eve, and New Year's Day.

6. The gaming machine of claim 1, wherein said external control source is another gaming machine.

7. The gaming machine of claim 1, wherein said plurality of audio data sets are in a digital surround-sound format.

8. The gaming machine of claim 1, wherein said audio speaker system includes one speaker.

9. The gaming machine of claim 1, wherein said audio speaker system includes a plurality of speakers.

10. The gaming machine of claim 9, wherein said plurality of speakers are in a non-planer spatial arrangement around a location where a player of said gaming machine is positioned.

11. A gaming machine network, comprising:
a plurality of gaming machines, each gaming machine of said plurality of gaming machines including a processor for randomly selecting one of a plurality of outcomes of said gaming machine in response to a wager amount and an audio speaker system broadcasting an audio output to a player of said gaming machine; and
a central controller electronically coupled to each of said plurality of gaming machines, said central controller sending audio instructions for controlling said audio outputs from said audio speaker systems of said plurality of gaming machines.

12. The gaming machine network of claim 11, wherein said audio instructions include audio data in a digital audio format.

13. The gaming machine network of claim 11, wherein said audio instructions include audio data in a digital surround-sound format.

14. The gaming machine network of claim 11, wherein said central controller monitors wager amounts to determine a favorite audio output, said audio instructions corresponding to said favorite audio output.

15. The gaming machine network of claim 11, wherein said central controller sends said audio instructions in response to real time being a predetermined time.

16. The gaming machine network of claim 11, wherein said central controller selectively sends said audio instructions to certain ones of said plurality of gaming machines.

17. The gaming machine network of claim 16, wherein said audio instructions that are sent to said certain ones of said plurality of gaming machines are different.

18. The gaming machine network of claim 11, wherein said audio instructions include streaming audio data.

19. The gaming machine network of claim 11, wherein said audio instructions include compressed audio data.

20. The gaming machine network of claim 19, wherein said gaming machines include a digital-to-analog converter and a power amplifier for processing said compressed audio data so as to broadcast said audio output.

21. The gaming machine network of claim 11, wherein said central controller selectively sends said audio instructions to a certain one of said plurality of gaming machines, said audio instructions corresponding to an audio output that contains a message for a player of said certain one of said plurality of gaming machines.

22. The gaming machine network of claim 21, wherein said message relates to an outcome achieved by said game.

23. The gaming machine network of claim 22, wherein said message includes music having lyrics that relate to said outcome.

24. The gaming machine network of claim 11, wherein said central controller selectively sends said audio instructions to each of said plurality of gaming machines in response to one of said games achieving a certain outcome.

25. The gaming machine network of claim 24, wherein said audio instructions sent to one of said plurality of gaming machines is different from said audio instructions sent to others of said plurality of gaming machines.

26. The gaming machine network of claim 24, wherein said audio instructions include music.

27. The gaming machine network of claim 24, wherein said audio instructions provide choreographed audio effects broadcasting from said audio speaker system of said plurality of gaming machines.

28. The gaming machine network of claim 11, wherein said audio instructions provide choreographed audio effects broadcasting from said audio speaker system of said plurality of gaming machines.

29. The gaming machine network of claim 28, wherein said choreographed audio effects include sequential actuation of said audio speaker systems of said plurality of gaming machines.

30. The gaming machine network of claim 11, wherein said audio speaker system of each of said plurality of gaming machines includes one speaker.

31. The gaming machine network of claim 11, wherein said central controller selectively sends said audio instructions to each of said plurality of gaming machines in response to a randomly selected event or time.

32. The gaming machine network of claim 11, wherein said audio speaker system of each of said plurality of gaming machines includes a plurality of speakers in a non-planer spatial arrangement around a location where a player is positioned at said respective gaming machine.

33. The gaming machine network of claim 11, wherein each of said plurality of gaming machines includes memory for storing audio data sets, each of said plurality of gaming machines selecting one of said audio data sets in response to receiving said audio instructions from said central controller.

34. The gaming machine network of claim 33, wherein said processor for each of said plurality of gaming machines selects said one of said audio data sets from said memory.

35. The gaming machine network of claim 11, wherein said central controller sends said audio instructions to at least one of said plurality of gaming machines in response to one of said plurality of gaming machines achieving a certain outcome of said plurality of outcomes.

36. The gaming machine network of claim 11, wherein at least one of said plurality of gaming machines includes a microphone for converting acoustic signals from a player to player-specific audio signals.

37. The gaming machine network of claim 36, wherein said player-specific audio signals are processed and broadcasted as an audio output from said audio speaker systems on one or more of said plurality of gaming machines.

38. A gaming machine network, comprising:
a plurality of electronically interconnected gaming machines, each gaming machine of said plurality of gaming machines including a processor for randomly selecting one of a plurality of outcomes of said gaming machine in response to a wager amount and an audio speaker system broadcasting an audio output to a player of said gaming machine, one of said plurality of gaming machines sending audio instructions to at least another of said plurality of gaming machines for controlling said audio output from said audio speaker system of said another of said plurality of gaming machines.

39. The gaming machine network of claim 38, wherein said audio instructions include audio data in a digital audio format.

40. The gaming machine network of claim 38, wherein said audio instructions include audio data sets in a digital surround-sound format.

41. The gaming machine network of claim 38, wherein said another of said plurality of gaming machines includes memory for storing audio data sets, said another of said plurality of gaming machines selecting one of said audio data sets in response to receiving said audio instructions.

42. The gaming machine network of claim 41, wherein said processor for said another of said plurality of gaming machines selects said one of said audio data sets from said memory.

43. The gaming machine network of claim 38, wherein said audio instructions sent to one of said plurality of gaming machines is different from said audio instructions sent to others of said plurality of gaming machines.

44. The gaming machine network of claim 38, further including a central controller interconnected to said plurality of gaming machines.

45. The gaming machine network of claim 44, wherein said another of said plurality of gaming machines downloads audio data from said central controller in response to receiving said audio instructions.

46. The gaming machine network of claim 38, wherein at least one of said plurality of gaming machines includes a microphone for converting acoustic signals to player audio signals, said player audio signals being processed and broadcasted as an audio output from said audio speaker systems of one or more of said plurality of gaming machines.

47. A method of operating a plurality of gaming machines, each of which is linked to a central controller, comprising:
broadcasting an audio output from said plurality of gaming machines;
selectively altering, via said central controller, said audio output for at least one of said plurality of gaming machines.

48. The method of claim 47, wherein said step of altering includes determining which one of said audio outputs broadcast from said plurality of gaming machines is a favorite audio output by monitoring wager inputs, and changing an audio output for certain ones of said plurality of gaming machines to said favorite audio output.

49. The method of claim 48, wherein said step of determining which one of said audio outputs is the favorite includes determining a first favorite for a first day of the week and a second favorite for a second day of the week.

50. The method of claim 47, wherein said step of altering includes downloading a selected audio data set from an external said memory device.

51. A method of operating a gaming machine that receives wager inputs and randomly selects outcomes after receiving said wager inputs, comprising:
broadcasting a first audio output from said gaming machine;
receiving audio data corresponding to a second audio output from an external memory device; and
broadcasting said second audio output from said gaming machine after said receiving step.

52. The method of claim 51, wherein said step of receiving is in response to real time being a predetermined time.

53. The method of claim 51, wherein said step of receiving includes downloading said audio data from a central controller that includes said external memory device.

54. The method of claim 51, wherein said audio data is in a digital format.

55. The method of claim 51, wherein said audio data is streaming audio data.

56. The method of claim 51, wherein said audio data is compressed audio data.

57. A method of operating a gaming machine that receives wager inputs and randomly selects outcomes of a wagering game after receiving said wager inputs, comprising:
transmitting, from an external source to said gaming machine, game-related audio data corresponding to a desired audio output; and
broadcasting said desired audio output from said gaming machine.

58. The method of claim 57, further including processing said game-related audio data at said gaming machine.

59. The method of claim 57, wherein said transmitting is in response to a certain event.

60. The method of claim 59, wherein said certain event is a certain outcome of said gaming machine.

61. The method of claim 59, wherein said certain event is a certain outcome of another gaming machine.

62. The method of claim 59, wherein said certain event is a receipt of a player input from a player of said gaming machine.

63. The method of claim 62, wherein said player input is an input requesting said desired audio output.

64. The method of claim 57, wherein said external source is a central controller coupled to said gaming machine.

65. The method of claim 57, wherein said game-related audio data is compressed audio data.

66. The method of claim 57, wherein said game-related audio data is streaming audio data.
